(19) United States
(12) Patent Application Publication
(10) Pub. No.: US 2017/0285550 A1
(43) Pub. Date: Oct. 5, 2017

(54) IMAGE FORMING SYSTEM

(71) Applicant: FUJI XEROX CO., LTD., Tokyo (JP)

(72) Inventors: Hiroaki AWANO, Kanagawa (JP); Yoshinori NAKANO, Kanagawa (JP); Takuya MAKITA, Kanagawa (JP); Kojiro TSUTSUMI, Kanagawa (JP); Katsumi HARADA, Kanagawa (JP); Yasuhiro KUSUMOTO, Kanagawa (JP); Hiroshi HAGIWARA, Kanagawa (JP); Emiko SHIRAISHI, Kanagawa (JP); Junichi HIROTA, Kanagawa (JP)

(73) Assignee: FUJI XEROX CO., LTD., Tokyo (JP)

(21) Appl. No.: 15/219,941

(22) Filed: Jul. 26, 2016

(30) Foreign Application Priority Data
Mar. 29, 2016 (JP) 2016-066591

(51) Int. Cl. G03G 15/00; B65H 37/04

(52) U.S. Cl. CPC G03G 15/6544; B65H 37/04; B65H 2801/48

(57) ABSTRACT

An image forming system includes an image forming unit configured to form an image on a sheet and provided in an apparatus body, a first sheet processing device provided in a first housing and configured to perform a first binding processing, without using a needle, on the sheet that is formed with the image and stacked, and a second sheet processing device provided in a second housing that is different from the first housing and configured to perform a second binding processing, using a needle, on the sheet that is formed with the image and stacked. The first housing and the second housing are mounted on the apparatus body. At least a portion of the first housing is positioned within a range exclusively occupied by a rectangular space defined by a maximum outer dimension of the apparatus body. The second housing is positioned outside the rectangular space.

### CROSS-REFERENCE TO RELATED APPLICATIONS

This application is based on and claims priority under 35 USC 119 from Japanese Patent Application No. 2016-066591 filed Mar. 29, 2016.

### BACKGROUND

### Technical Field

The present invention relates to an image forming system.

### SUMMARY

According to an aspect of the invention, an image forming system includes an image forming unit configured to form an image on a sheet and provided in an apparatus body, a first sheet processing device provided in a first housing and configured to perform a first binding processing, without using a needle, on the sheet that is formed with the image by the image forming unit and stacked, and a second sheet processing device provided in a second housing that is different from the first housing and configured to perform a second binding processing, using a needle, on the sheet that is formed with the image by the image forming unit and stacked. The first housing and the second housing are mounted on the apparatus body. At least a portion of the first housing is positioned within a range exclusively occupied by a rectangular space defined by a maximum outer dimension of the apparatus body. The second housing is positioned outside the rectangular space.

### BRIEF DESCRIPTION OF THE DRAWINGS

Exemplary embodiments of the present invention will be described in detail based on the following figures, wherein:

FIG. 1 is a view illustrating an entire configuration of an image forming system according to a first exemplary embodiment;

FIG. 2 is a view illustrating a configuration of a first sheet processing device and a second sheet processing device, and illustrating the upper part of the image forming system illustrated in FIG. 1 in an enlarged scale;

FIGS. 3A and 3B are views illustrating a needle-free binding mechanism according to the present exemplary embodiment;

FIG. 4 is a flowchart illustrating an example of a selection procedure performed by a controller; and

FIG. 5 is a view illustrating an entire configuration of an image forming system according to a second exemplary embodiment.

### DETAILED DESCRIPTION

### First Exemplary Embodiment

Hereinafter, an exemplary embodiment of the present invention will be described with reference to the accompanying drawings.

### <Description of Image Forming System 1>

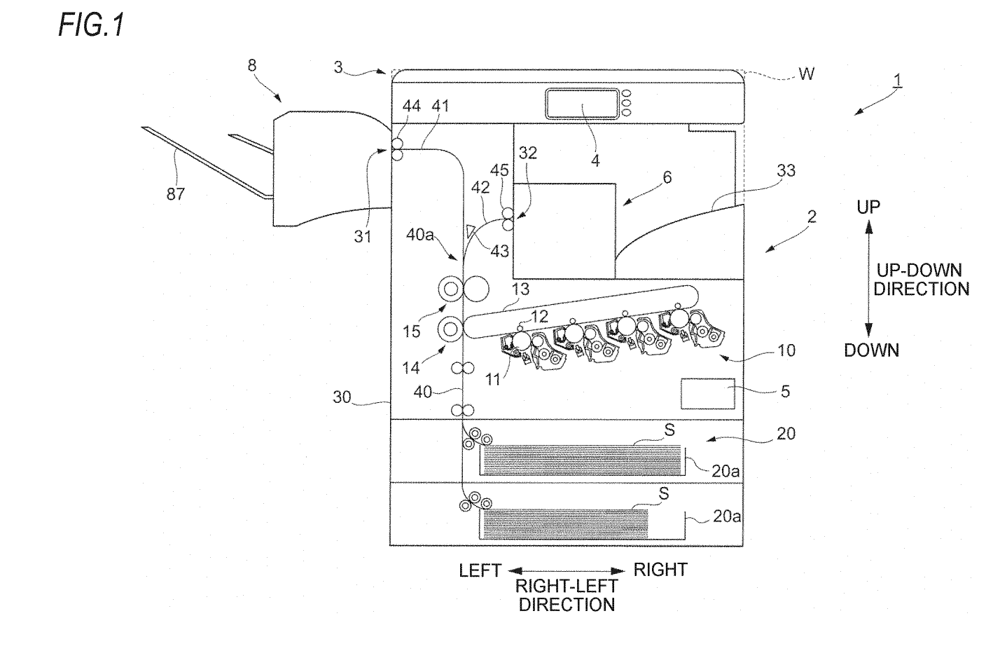

FIG. 1 is a view illustrating an entire configuration of an image forming system according to the present exemplary embodiment. The image forming system according to the first exemplary embodiment includes, for example, an image forming apparatus 2 that forms an image on a sheet, an image reader 3 that reads an image formed on an original document, and an operation reception apparatus 4 that receives operation instructions from an operator and displays various information with respect to the operator. The image forming system 1 includes, for example, a central processing unit (CPU), a read only memory (ROM), a random access memory (RAM), and includes a controller 5 that controls an operation of the image forming system 1, as an example of a selection unit.

In this example, the image reader 3 and the operation reception apparatus 4 are provided at a vertically upper part of the image forming apparatus 2. The controller 5 is provided inside a housing 30, which will be described later, of the image forming apparatus 2.

Furthermore, the image forming system 1 includes a first sheet processing device 6 that performs a first binding processing (needle-free binding processing) on a sheet on which an image is formed by the image forming apparatus 2 and a second sheet processing device 8 that performs a second binding processing (needle binding processing), which is different from the first binding processing, on a sheet on which an image is formed by the image forming apparatus 2.

In the image forming system according to the present exemplary embodiment, each of the first sheet processing device 6 and the second sheet processing device 8 is detachably provided to the housing 30, which will be described later, of the image forming apparatus 2.

In the following description, a width direction of the image forming system 1 illustrated in FIG. 1 may be simply referred to as a “right-left direction” and a height direction of the image forming system 1 may be simply referred to as an “up-down direction”.

In the housing 30, a range exclusively occupied by a rectangular space (rectangular parallelepiped shape) defined by the maximum dimension in each of the right-left direction, the up-down direction, and a depth direction of the housing 30 may be simply referred to as an “installation range W.”

In the image forming system 1 according to the present exemplary embodiment, as illustrated in FIG. 1, the first sheet processing device 6 is provided inside the installation range W. Whereas, the second sheet processing device 8 is provided outside the installation range W of the image forming apparatus 2.

In other words, the first sheet processing device 6 is positioned below the image reader 3 in the up-down direction (vertical direction) and the second sheet processing device 8 is provided to protrudes laterally from the lower part of the image reader 3 in the up-down direction (vertical direction) In other words, the first sheet processing device 6 is positioned above the bottom surface of the image forming system 1 in the up-down direction (vertical direction) and the second sheet processing device 8 is provided to protrude laterally from a portion above the bottom surface of the image forming system 1 in the up-down direction (vertical direction).

In addition, the configurations of the first sheet processing device 6 and the second sheet processing device 8, the first binding processing performed in the first sheet processing device 6, the second binding processing performed in the second sheet processing device 8, and a positional relationship between the first sheet processing device 6 and the second sheet processing device 8 will be described in detail in the following sections.

### <Image Forming Apparatus 2>

The image forming apparatus 2 includes an image forming unit 10 that is configured in a so-called tandem type and forms an image based on individual color image data and a sheet supply unit 20 that includes plural sheet trays 20a (two (2) paper trays in this example) each configured to accommodate sheets S and supplies the sheets S to the image forming unit 10.

In addition, the image forming apparatus 2 includes a housing 30 that accommodates the image forming unit 10 and the sheet supply unit 20 therein.

Further, the image forming apparatus 2 includes a sheet transport path 40 in which sheets are transported from the sheet supply unit 20 to the first sheet processing device 6 and the second sheet processing device 8 through the image forming unit 10.

The image forming unit 10 includes four (4) photoconductor drums 11 corresponding to four colors of black (K) yellow (Y), magenta (K), and cyan (C), respectively, and arranged in parallel to each other in a horizontal direction, four (4) primary transfer rolls 12 arranged to correspond to the four photoconductor drums, respectively, an intermediate transfer belt 13 onto which toner images formed on the respective photoconductor drums are primarily transferred in sequence, secondary transfer roll 14 that secondarily transfers the toner images, which are primarily transferred on the intermediate transfer belt 13, onto the sheet S, and a fixing device 15 that fixes the toner images to the sheet S after the secondary transfer.

Here, around each photoconductor drum 11, for example, a charging device that charges a surface of the of the photoconductor drum 11, a laser writing device (riot illustrated) that forms an electrostatic latent image by irradiating laser light on the surface of the photoconductor drum 11 charged by the charging device, a developing device that develops the electrostatic latent image formed on the photoconductor drums using respective color toners to visualize the electrostatic latent image, and a cleaner that removes toner remaining on the photoconductor drums after the primary transfer, are disposed.

Whereas, each of the primary transfer rolls 12 is disposed to be opposite to the corresponding one of the photoconductor drums 11 across the intermediate transfer belt 13. Each of the primary transfer rolls 12 primarily transfers a toner image formed on the corresponding one of the photoconductor drums 11 onto the intermediate transfer belt 13.

The secondary transfer roll 14 is provided to be opposite to the intermediate transfer belt 13. The secondary transfer roll 14 collectively and electrostatically transfers (secondarily transfers) respective color toner images, which have been primarily transferred in sequence on the intermediate transfer belt 13, to a sheet S.

The fixing device 15 includes, for example, a heating member having a heat source therein and a pressing member that forms a pressing section with the heating member. When the sheet S passes through the pressing section, the toner images are fixed to the sheet S by being heated and pressed.

In the image forming unit 10, the sheet S is supplied from the sheet supply unit 20 to the secondary transfer roll 14 according to timing at which each color toner image on the intermediate transfer belt 13 is transported to an arrangement position of the secondary transfer roll 14, and the color toner images are collectively and electrostatically transferred collectively to the sheet S by the action of a transfer electric field formed by the secondary transfer roll 14.

Thereafter, the sheet S, to which each color toner image is secondarily transferred, is peeled off from the intermediate transfer belt 13 and transported to the fixing device 15, such that each color toner image is fixed on the sheet S to form a color image on the sheet S.

The sheet S, on which the color image is formed, is discharged from the image forming apparatus 2, and transported to the first sheet processing device 6 or the second sheet processing device 8 connected to the image forming apparatus 2.

As illustrated in FIG. 1, the housing 30 as an example of an apparatus body generally has a substantially rectangular parallelepiped shape and accommodates, for example, respective components of the image forming unit 10 and the sheet supply unit 20, and the controller 5.

The housing 30 includes a first exit port 31 that discharges the sheet S on which an image is formed in the image forming unit 10 toward the second sheet processing device 8 and a second exit port 32 that discharges the sheet S on which an image is formed in the image forming unit 10 toward the first sheet processing device 6.

In addition, the housing 30 includes a body side stacking unit 33 in which, for example, sheets S or a sheet bundle discharged from the first sheet processing device 6 are stacked, a second mounting unit (not illustrated) provided adjacent to the first exit port 31 and configured to mount a second housing 86, which will he described later, of the second sheet processing device 8 thereon, and a first mounting unit (not illustrated) provided adjacent to the second exit port 32 and configured to mount the first housing 66, which will be described later, of the first sheet processing device 6 thereon.

As illustrated in FIG. 1, in this example, the first exit port 31 is disposed such that an opening thereof is directed toward the left side of the housing 30, the second exit port 32 is disposed such that an opening thereof is directed toward the right side of the housing 30, and the first exit port 31 and the second exit port 32 are provided in opposite side surfaces in the housing 30. That is, a discharge direction of a sheet S discharged from the first exit port 31 is a left direction, a discharge direction of the sheet S discharged from the second exit port 32 is a right direction, so that the discharge directions of the sheets S discharged from the first exit port 31 and the second exit port 32 are opposite to each other.

In addition, the installation position of the first exit port 31 is higher than the installation position of the second exit port 32 in the up-down direction.

As illustrated in FIG. 1, the sheet transport path 40 includes a branch section 40a, at which the transport directions of sheets S are split, at the downstream side of the fixing device 15 in the image forming unit 10. The sheet transport path 40 includes a first transport path 41 that transports sheets S from the branch section 40a to the first exit port 31 and a second transport path 42 that transports sheets S from the branch section 40a to the second exit port 32.

In addition, at the branch section 40a of the sheet transport path 40, a distribution mechanism 43 is provided to distribute the sheets 5, which are transported from the image forming unit 10 to the branch section 40a, to the first transport path 41 or the second transport path 42. The distribution mechanism 43 distributes the sheets S based on the control by the controller 5.

Further, in the first transport path 41 of the sheet transport path 40, first discharge rolls 44 are provided to discharge the sheets 5, which are transported to the first transport path 41, from the first exit port 31 toward the second sheet processing device 8. Moreover, in the second transport path 42 of the sheet transport path 40, second discharge rolls 45 are provided to discharge the sheets 5, which are transported to the second transport path 42, from the second exit port 32 toward the first sheet processing device 6.

The sheets S transported in the first transport path 41 are discharged from the first exit port 31 to the second sheet processing device 8 by the first discharge rolls 45 in a state where a surface on which an image is formed (image forming surface) is directed upward (face-up state).

Meanwhile, the sheets S transported in the second transport path 42 are discharged from the second exit port 32 to the first sheet processing device 6 in a state where the image forming surface is directed downward (face-down state).

Subsequently, descriptions will be made on the first sheet processing device 6 and the second sheet processing device 8.

### <First Sheet Processing Device 6>

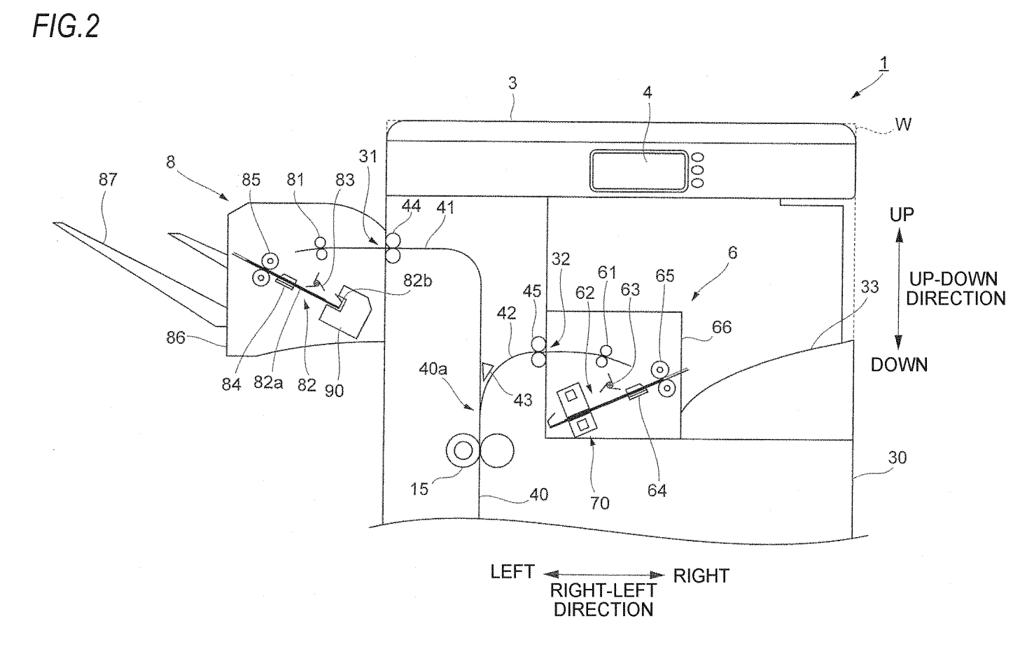

FIG. 2 is a view for describing a configuration of the first sheet processing, device 6 and the second sheet processing device 8 in detail, and illustrating the upper part of the image forming system 1 illustrated in FIG. 1 in an enlarged scale.

The first sheet processing device 6, to which the present exemplary embodiment is applied, includes first transport rolls 61 that transport the sheet discharged from the second exit port 32 of the image forming apparatus 2 to the further downward side and a first compiling tray 62 that causes sheets S each having an image formed thereon to be accumulated by a predetermined number.

The first sheet processing device 6 includes a first paddle 63 that rotates to press a rear end of the sheets S and a first damper 64 that aligns both ends of the sheets S in the depth direction.

Furthermore, the first sheet processing device 6 includes a needle-free binding mechanism 70, as an example of a first mechanical unit, that performs a binding processing performed without using a staple needle with respect to the sheets S accumulated in the first compiling tray 62 (needle-free binding processing), as a first binding processing. The first sheet processing device 6 includes first ejection rolls 65 that discharges the sheet bundle subjected to the needle-free binding processing by the needle-free binding mechanism 70, to the outside of the first sheet processing device 6.

The first sheet processing device 6 is accommodated in the first housing 66. The first housing 66 is removably mounted on the first mounting unit (not illustrated) provided in the housing 30 of the image forming apparatus 2.

The needle-free binding mechanism 70 performs a processing of binding the sheet bundle aligned in the first compiling tray 62 by pressing the sheet bundle to rupture and press-bond the fibers of the sheets S without using a staple needle. In addition, the needle-free binding mechanism 70 is configured to be movable on a rail (not illustrated) by receiving a driving force from a driving motor (not illustrated).

Subsequently, descriptions will be made on a needle-free binding processing procedure performed in the first sheet processing device 6 according to the present exemplary embodiment.

The sheets S carried into the first sheet processing device 6 from the image forming apparatus 2 are transported by the first transport rolls 61 and the first paddle 63 to the first compiling tray 62 in a state where the image forming surfaces thereof are directed downward. In addition, when a predetermined number of sheets S are aligned by the first compiling tray 62 and the first damper 64 and a sheet bundle is generated.

Then, the needle-free binding mechanism 70 moves to a predetermined binding position and the binding processing is performed.

In a case where the binding is performed on a single position of the sheet bundle on the first compiling tray 62, the needle-free binding mechanism 70 is stopped at a predetermined home position and sequentially performs the needle-free binding processing at a required timing.

Meanwhile, in a case where the binding is performed on two positions of the sheet bundle, the needle-free binding mechanism 70 is moved to the predetermined binding position on a rail by a driving force of the driving motor and performs the needle-free binding processing on the two positions of the sheet bundle.

Thereafter, the sheet bundle subjected to the binding processing is discharged to the body side stacking unit 33 by the first ejection rolls 65 in the state where the image forming surfaces are directed upward.

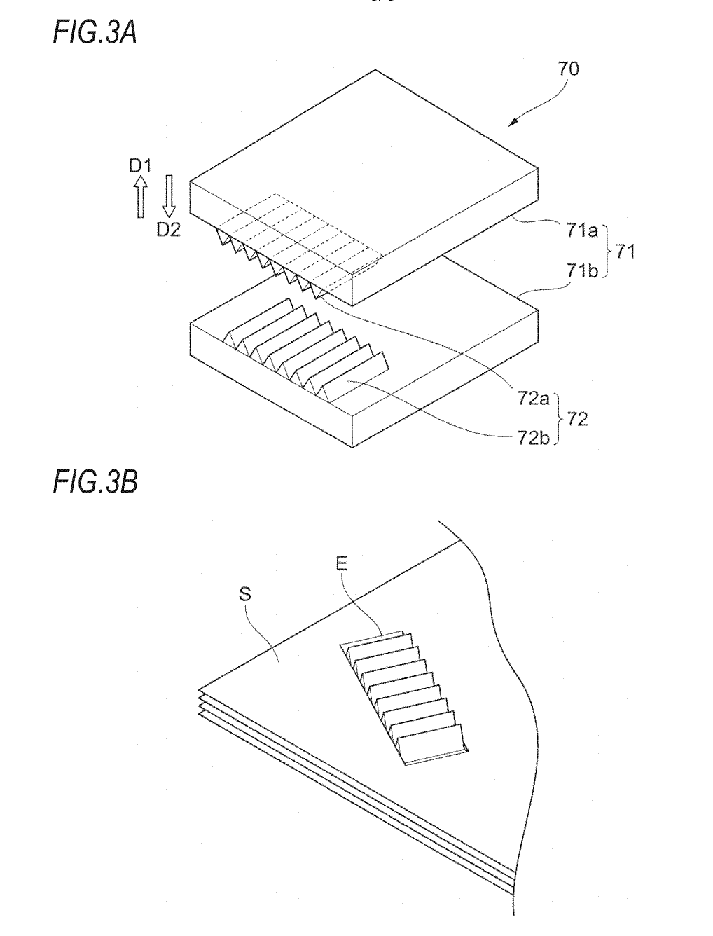

Subsequently, descriptions will be made on a configuration of the needle-free binding mechanism 70 and the needle-free binding processing. FIGS. 3A and 3B are views for describing the needle-free binding mechanism 70 according to the present exemplary embodiment. FIG. 3A schematically illustrates the needle-free binding mechanism 70 in a perspective view and FIG. 3B illustrates an end part of a sheet bundle subjected to the binding processing by the needle-free binding mechanism 70.

The needle-free binding mechanism 70, to which the present exemplary embodiment is applied, includes pressing units 71 that come close to each other to supply a pressure for processing the end part of the sheets S and an embossing mark forming unit 72 that receives the pressure from the pressing units 71 to bind the sheets S, thereby binding the sheet bundle.

The pressing units 71 are constituted with an upper pressing unit 71a disposed to face a surface which is located opposite to the image forming surface side of the sheet bundle generated in the first compiling tray 62 (see FIG. 2) and a lower pressing unit 71b disposed to face the image forming surface side of the sheet bundle. The upper pressing unit 71a is provided to be movable back and forth with respect to the lower pressing unit 71b by the upper pressing unit motor (not illustrated) (see arrows D1 and D2 of FIG. 3A). The upper pressing unit 71a and the lower pressing unit 71b are configured to apply a pressure to the sheet bundle generated in the first compiling tray 62.

The embossing mark forming unit 72 is constituted with a convex part 72a provided on the upper pressing unit 71a and protruding toward the lower pressing unit 71b and a receiving part 72b provided on the lower pressing unit 71b and including concave and convex portions corresponding to the shape of the convex part 72a. The convex part 72a and the receiving part 72b are configured to process the sheet bundle inserted therebetween.

Specifically, a surface, which is opposite to the receiving part 72b, of the convex part 72a is provided with the concave convex portions and a surface, which is opposite to the convex part 72a, of the receiving part 72b is provided with concave and convex portions. The surface on which the concave and convex portions of the convex part 72a are formed the surface on which the concave and convex portions of the receiving part 72b are formed are substantially parallel with each other and are disposed such that the convex portions of the convex part 72a and the concave portions of the receiving part 72b are engaged with each other.

In addition, the convex part 72a and the receiving part 72b are configured to be engaged with each other when receiving the pressure from by the pressing units 71, thereby processing the sheet bundle.

As illustrated in FIG. 3B, in a processed portion of the sheets S (sheet bundle), concave and convex portions are formed over the overlapping direction of the sheets S to correspond to the shapes of the convex part 72a and the receiving part 72b. Accordingly, the fibers of the sheets S are ruptured in the processed portion of the sheets S and press-bonded to each other. As a result, an embossing mark E is formed to bind the sheet bundle without using a staple needle.

### <Second Sheet Processing Device 8>

Returning back to FIG. 2, the second sheet processing device 8 of the present exemplary embodiment includes second transport rolls 81 that transport the sheets discharged from the first exit port 31 of the image forming apparatus 2 to the further downward side, a second compiling tray 82 in which the predetermined number of sheets S having an image formed thereon are accumulated, a second paddle 83 that rotates to press a rear end of the sheets S toward an end guide 82a of the second compiling tray 82, and a second damper 84 that aligns both ends of the sheets S accumulated on the second compiling tray 82 (both ends in the direction orthogonal to the transport direction of the sheets).

The second sheet processing device 8 includes a needle binding mechanism 90, as an example of a second mechanical unit, that performs a binding processing (needle binding processing) as a second binding processing using a staple needle with respect to the sheets S accumulated in the second compiling tray 82, second ejection rolls 85 that discharge a sheet bundle subjected to the needle binding processing by the needle binding mechanism 90, and a processing device side stacking unit 87 in which the sheets S discharged by the second ejection rolls 85 are stacked.

Furthermore, the second sheet processing device 8 is accommodated in the second housing 86.

In the image forming system 1, to which the present exemplary embodiment is applied, the processing device side stacking unit 87 protrudes from the second housing 86. In the up-down direction, the height of the installation position of the processing device side stacking unit 87 of the second sheet processing device 8 is higher than the height of the installation position of the body side stacking unit 33.

The second transport rolls 81, the second compiling tray 82, the second paddle 83, the second damper 84, and the second ejection rolls 85 of the second sheet processing device 8 have the same structures as the first transport roll 61, the first compiling tray 62, the first paddle 63, the first damper 64, the first ejection rolls 65 of the first sheet processing device 6, respectively.

Accordingly, detailed descriptions of the structures and operations thereof will be omitted.

Subsequently, descriptions will be made on a procedure of the needle binding processing performed in the second sheet processing device 8 according to the present exemplary embodiment.

The sheets S carried into the second sheet processing device 8 from the image forming apparatus 2 are transported to the second compiling tray 82 by the second transport rolls 81 and the second paddle 83 in a state where the image forming surfaces are directed upward. Then, a predetermined number of sheets S are aligned by the second compiling tray 82 and the second damper 84 such that a sheet bundle is generated.

Then, the needle binding mechanism 90 moves to a predetermined binding position and a binding processing using a staple needle is performed. Specifically, the staple needle is pressed to the sheet bundle generated in the second compiling tray 82 from the image forming surface side by the needle binding mechanism 90 and thus, the binding processing is performed.

Thereafter, the second ejection rolls 85 rotate and thus, the sheet bundle subjected to the binding processing is discharged to the processing device side stacking unit 87 in a state where the image forming surfaces are directed downward.

### <Description of Control by Controller 5>

In the image forming system 1, to which the present exemplary embodiment is applied, when a binding processing is performed on the sheet bundle, any of the needle-free binding processing by the first sheet processing device 6 and the needle binding processing by the second sheet processing device 8 is selected.

In the image forming system 1, a user selection mode, in which a selection is made by the user through, for example, an operation reception apparatus 4 and an automatic selection mode, in which a selection is made automatically by the controller 5, are set as modes for selecting the needle-free binding processing and the needle binding processing.

However, in the needle-free binding processing for binding a sheet bundle without using a staple needle by the needle-free binding mechanism 70 of the first sheet processing device 6, the sheet bundle tends to be easily unbound compared to the needle binding processing for binding the sheet bundle using the staple needle by the needle binding mechanism 90 of the second sheet processing device 8.

In other words, a bonding strength between the sheets S constituting the sheet bundle tends to be small in the needle-free binding processing compared to the needle binding processing. In particular, in the needle-free binding processing of the first sheet processing device 6, the sheet bundle is easily unbound when the number of sheets S to be bound as a sheet bundle is large.

On the contrary, in the image forming system 1 of the present exemplary embodiment, the needle binding processing by the second sheet processing device 8 is selected based on the control by the controller 5 when the number of sheets S to be bound as the sheet bundle is large in the automatic selection mode.

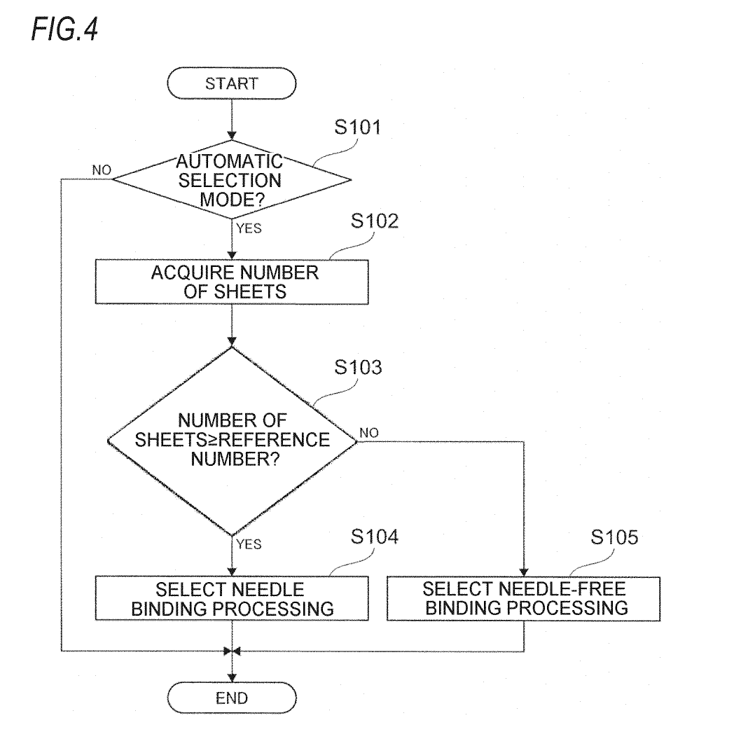

FIG. 4 is a flowchart illustrating an example of a procedure of selection by the controller 5.

Hereinafter, descriptions will be made on the procedure of the needle-free binding processing by the first sheet processing device 6 or the needle binding processing by the second sheet processing device 8 according to the control of the controller 5.

In a case where a user issues an instruction to accumulate plural sheets S to perform the binding processing using, for example, the operation reception apparatus 4, the controller 5 determines whether the automatic selection mode is set (Step 101).

When the automatic selection mode is not set (“NO” at Step 101), that is, when the user selection mode is set, the needle-free binding processing by the first sheet processing device 6 or the needle binding processing by the second sheet processing device 8 is selected based on the selection by the user, and a series of processings are ended.

Meanwhile, when the automatic selection mode is set (“YES” at Step 101), the controller 5 acquires the number of sheets S to be subjected to the binding processing (Step 102), and determines whether the acquired number of sheets is equal to or larger than the predetermined reference number of sheets (e.g., ten (10) sheets) (Step 103).

When the number of sheets is equal to or larger than the reference number of sheets (“YES” at Step 103), the controller 5 selects the needle binding processing to be performed by the second sheet processing device 8 (Step 104), and terminates a series of processings.

On the other hand, when the number of sheets S is less than the reference number of sheets (“NO” at Step 103), the controller 5 selects the needle-free binding processing to be performed by the first sheet processing device 6 (Step 105), and terminates a series of processings.

In addition, based on a selection result by each selection mode, the controller 5 controls the distribution mechanism 43 to distribute the sheets S, which are formed with an image in the image forming unit 10, to the first sheet processing device 6 or the second sheet processing device 8.

Specifically, in a case where the needle-free binding processing is selected, the controller 5 transports the sheets S to the second transport path 42 and distributes the sheets to the first sheet processing device 6 by the distribution mechanism 43. In a case where the needle binding processing is selected, the controller 5 transports the sheets S to the first transport path 41 and distributes the sheets to the second sheet processing device 8 by the distribution mechanism 43.

In this way, in the image forming system 1 of the present exemplary embodiment, the needle binding processing by the second sheet processing device 8 is selected when the number of sheets S constituting a sheet bundle is larger than the reference number of sheets in the automatic selection mode. Accordingly, the unbinding of the sheet bundle may be suppressed compared to, for example, a case where the needle-free binding processing by the first sheet processing device 6 is selected when the number of sheets S constituting the sheet bundle is larger than the reference number of sheets.

In addition, in the image forming system 1 of the present exemplary embodiment, the needle-free binding processing by the first sheet processing device 6 is selected when the number of sheets S constituting a sheet bundle is less than the reference number of sheets in the automatic selection mode. Accordingly, the consumption of staple needles may be reduced compared to, for example, a case where the needle binding processing by the second sheet processing device 6 is selected when the number of sheets S constituting a sheet bundle is less than the reference number of sheets.

### <Positions of First Sheet Processing Device 6 and Second Sheet Processing Device 8>

As described above, the image forming system 1 of the present exemplary embodiment separately includes a first sheet processing de vice 6 including a needle-free binding mechanism 70 to perform a needle-free binding processing without using a staple needle on sheets S and a second sheet processing device 8 including the needle binding mechanism 90 to perform a needle binding processing using a staple needle on sheets S.

Hereinafter, the arrangement of the first sheet processing device 6 and the second sheet processing device 8 in the image forming system 1, to which the present exemplary embodiment is applied, will be described in more detail with reference to FIG. 1 and FIG. 2.

In the image forming system 1, to which the present exemplary embodiment is applied, the first housing 66 in which the first sheet processing device 6 is accommodated and the second housing 86 in which the second sheet processing device 8 is accommodated are configured to be individually detachable from/attachable to different positions of the housing 30 of the image forming apparatus 2.

In addition, in the image forming system 1, to which the present exemplary embodiment is applied, the first housing 66, in which the first sheet processing device 6 including the needle-free binding mechanism 70 is accommodated, is provided inside the installation range W of the image forming system 1, and the second housing 86, in which the second sheet processing device 8 including the needle binding mechanism 90 is accommodated, is provided outside the installation range W of the image forming system 1.

More specifically, the first housing 66 (needle-free binding mechanism 70) is provided in a space surrounded by the housing 30 and the image reader 3. That is, the first housing 66 is surrounded by four surfaces of the top side, the left side, the back side, and the bottom side thereof. Meanwhile, the second housing 86 (needle binding mechanism 90) is provided in an opened space at the left side of the housing 30.

In addition, in the image forming system 1, to which the present exemplary embodiment is applied, as illustrated in FIG. 1, the length of the second transport path 42 in the first sheet processing device 6 including the needle-free binding mechanism 70 (the length from the branch section 40a to the second exit port 32) is shorter than the length of the first transport path 41 in the second sheet processing device 8 including the needle binding mechanism 90 (the length from the branch section 40a to the first exit port 31).

In addition, since a configuration in which the first sheet processing device 6 including the needle-free binding mechanism 70 is installed inside the installation range W of the image forming system is adopted, the binding work of the needle-free binding mechanism 70 may be executed more quietly in the image forming system, to which the present exemplary embodiment is applied.

Hereinafter, descriptions will be made on the operation sound accompanied by the binding work of the needle-free binding mechanism 70.

First, as described above, when the binding processing is performed by the needle-free binding mechanism 70, the needle-free binding mechanism 70 applies pressure to the sheets S to rupture the fibers of the sheets S to press-bond the sheets S, thereby binding the sheets S. On the other hand, when the binding processing is performed by the needle binding mechanism 90, the needle binding mechanism 90 inserts staple needles into the sheets S, thereby binding the sheets S.

The operation sound generated by the needle-free binding mechanism 70 during the binding process is louder than the operation sound generated during the binding process of the needle binding mechanism 90.

Thus, in the image forming system 1, to which the present exemplary embodiment is applied, the first housing 66 (needle-free binding mechanism 70) is installed inside the installation range W as described above. Thus, compared to, for example, a case where the first housing 66 is installed in a more opened space like the place where the second housing 86 (needle binding mechanism 90) is provided in FIG. 1, the transfer of the operation sound generated by the needle-free binding mechanism 70 can be partially blocked by the corresponding parts of the housing 30 and the image reader 3 around the first housing 66.

As a result, the operation sound transferred from the needle-free binding mechanism 70 (first housing 66) to the outside of the image forming system 1 is suppressed.

By adopting the configuration in which the second housing 86 (needle binding mechanism 90) is installed outside the installation range W of the image forming system 1, the replacement work (replenishing work) of staple needles of the needle binding mechanism 90 can be executed more quietly in the image forming system 1, to which the present exemplary embodiment is applied.

Hereinafter, descriptions will be made on the operation sound accompanied by the staple needle replacement work of the needle binding mechanism 90.

First, as a comparative example different from the example illustrated in FIG. 1, descriptions will be made on a configuration in which the second housing 86 is installed inside the installation range W (a space surrounded by the housing 30 and the image reader 3).

In this configuration, a line of sight of an operator who performs the work with respect to the needle binding mechanism 90 may be hindered by the image reader 3. That is, the image reader 3 becomes an obstacle for the line of sight of the operator. In addition, since the top side is covered by the image reader 3 the inside of the space becomes dark. Thus, when replacing staple needles, for example, the operator's hand or arm of the operator collides with, for example, the housing 30 or the image reader 3.

On the other hand, in a case where the second housing 86 (needle binding mechanism 90) is installed in an opened space as in the image forming system 1, to which the present exemplary embodiment illustrated in FIG. 1 is applied, there is no obstacle for the line of sight of the operator when replacing the staple needles and the required brightness is secured. Accordingly, the operator can easily perform the replacement work when replacing the staple needles. In other words, the collision of the operator's hand or the like with the housing 30 or the like may be suppressed and the collision sound caused by the collision is reduced.

Additionally, as described above, the length of the second transport path 42 that transports the sheets S to the first sheet processing device 6 including the needle-free binding mechanism 70 is shorter than the length of the first transport path 41 that transports the sheets S to the second sheet processing device 8 including the needle binding mechanism 90.

With this configuration, the installation position of the first sheet processing device 6 where the sheets S are received from the second transport path 42 is lower than the installation position of the second sheet processing device 8 where the sheets S are received from the first transport path 41 in the up-down direction.

Here, in a case where the operator's head is positioned above the second sheet processing device 8, the distance from the installation position of the first sheet processing device 6 to the operator's ears of the operator is farther than the distance from the second sheet processing device 8 to the operator's ears.

Accordingly, the operation sound generated by the first sheet processing device 6 during the binding process can be reduced in terms of the operator's acoustic sense. In addition, by adopting the configuration, the binding work of the needle-free binding mechanism 70 can be executed more quietly in the image forming system 1, to which the present exemplary embodiment is applied.

In addition, the length of the second transport path 42 is shorter than the length of the first transport path 41. Thus, when the sheet transport velocities in the first transport path 41 and the second transport path 42 are equal to each other, the time required for transporting a sheet formed with an image in the image forming unit 10 to the first sheet processing device 6 is reduced compared to the time required for transporting the sheet to the second sheet processing device 8. Accordingly, the processing time required for the first sheet processing device 6 is reduced.

In addition, by adopting the configuration in which the first housing 66 accommodating the first sheet processing device 6 and the second housing 86 accommodating the second sheet processing device 8 are individually detachable from the housing 30, it is possible to respond to an operator who requests both the needle binding processing and the needle-free binding processing and an operator who requests one of the needle binding processing and the needle-free binding processing, as a binding processing for sheets S.

That is, for the operator who requests both the needle binding processing and the needle-free binding processing, both the first sheet processing device 6 and the second sheet processing device 8 may be mounted on the image forming apparatus 2 in the image forming system 1.

On the contrary, for the operator who requests only the needle-free binding processing, for example, the second sheet processing device 8 may be removed and only the first sheet processing device 6 may be mounted in the image forming system 1. Similarly, for the operator who requests only the needle-free binding processing, the first sheet processing device 6 may be removed and only the second sheet processing device 8 may be mounted in the image forming system 1.

In this case, for example, in the configuration of the image forming system 1, the image forming system 1 is simplified compared to the case where both the first sheet processing device 6 and the second sheet processing device 8 are mounted.

In the present exemplary embodiment, the image forming system 1 is implemented according to the operator's request by a simple operation of attaching/detaching the first sheet processing device 6 or the second sheet processing device 8 to/from the image forming apparatus 2.

Furthermore, in the image forming system 1, to which the present exemplary embodiment is applied, for example, in a case where a problem occurs in one of the first sheet processing device 6 and the second sheet processing device 8 or maintenance is performed on one of the first sheet processing device 6 and the second sheet processing device 8, only the one of the first sheet processing device 6 and the second sheet processing device 8 may be removed from the image forming apparatus 2 such that the binding processing may be continued in the other of the first sheet processing device 6 and the second sheet processing device 8.

For example, even if the first sheet processing device 6 is removed from the image forming apparatus 2 for the maintenance, the needle binding processing by the needle binding mechanism 90 may be continued in the second sheet processing device 8.

For this reason, in the present exemplary embodiment, the occurrence of a situation in which the binding processing is not performed is suppressed compared to a case where the needle-free binding mechanism 70 and the needle binding mechanism 90 are provided in the same apparatus.

### Second Exemplary Embodiment

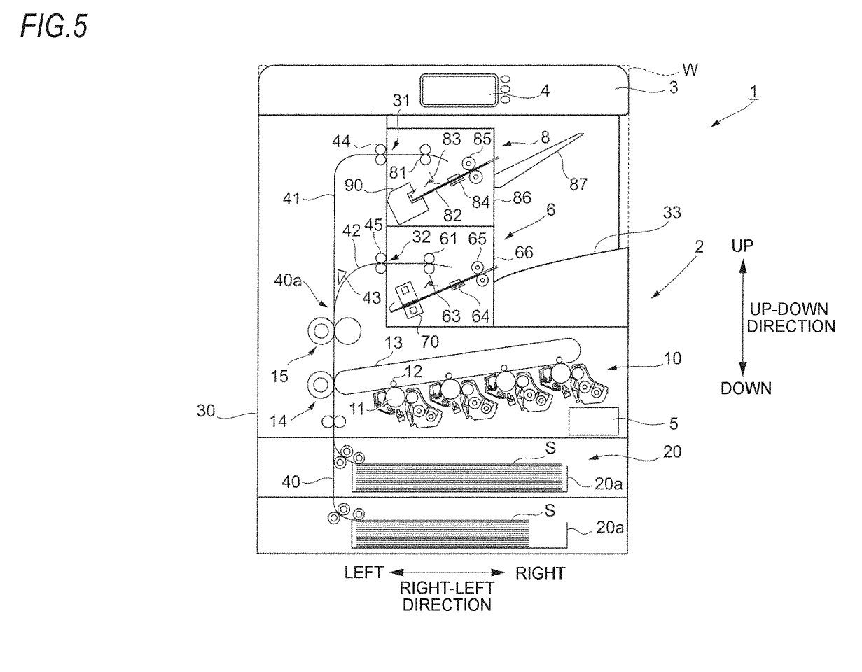

Subsequently, a second exemplary embodiment of the present invention will be described. FIG. 5 is a view illustrating an entire configuration of the image forming system 1 according to the second exemplary embodiment. In addition, in the image forming system 1 of the second exemplary embodiment, the components similar to those of the exemplary embodiment are denoted by the similar reference numerals, and detailed descriptions thereof will be omitted.

As in the first exemplary embodiment, the image forming system 1 of the second exemplary embodiment includes an image forming apparatus 2, an image reader 3, an operation reception apparatus 4, and a controller 5. In addition, the image forming system 1 of the second exemplary embodiment includes a first sheet processing device 6 that performs a needle-free binding processing on sheets S and a second sheet processing device 8 that performs a needle binding processing on sheets S.

In the image forming system 1 of the second exemplary embodiment, the first sheet processing device 6 is accommodated in the first housing 66, and the second sheet processing device 8 is accommodated in the second housing 86. In addition, each of the first housing 66 and the second housing 86 is configured to be individually detachable from the housing 30 of the image forming apparatus 2.

In addition, as illustrated in FIG. 5, the first housing 66 and the second housing 86 are provided inside the installation range W in which the image forming apparatus 2 is installed. Further, the second housing 86 is provided above the first housing 66.

Specifically, the first housing 66 and the second housing 86 are provided to be aligned in such a way that the second housing 86 is positioned above the first housing 66 with respect to the housing 30 of the image forming apparatus 2. In addition, the height of the first housing 66 is lower than the height of the second housing 86. That is, the top side of the first housing 66 is covered by the second housing 86.

The transfer of operation sound generated by the needle-free binding mechanism 70 accommodated in the first housing 66 may be partially blocked by the second housing 86 located above the needle-free binding mechanism 70. That is, since the needle-free binding mechanism 70 accommodated in the first housing 66 is surrounded by the second housing 86 and the housing 30, the operation sound of the needle-free binding mechanism 70 is suppressed.

Furthermore, since the needle binding mechanism 90 accommodated in the second housing 86 is surrounded by the housing 30, the image reader 3, and the first housing 66, the operation sound of the needle binding mechanism 90 is suppressed.

In addition, in the image forming system 1 of the second exemplary embodiment, the shape of the sheet transport path 40 is different from that of the first exemplary embodiment.

Specifically, as illustrated in FIG. 5, in the sheet transport path 40, the transport direction of sheets S in the image forming unit 10, the exit direction of sheets S discharged from the first exit port 31 to the second sheet processing device 8 through the first transport path 41, and the exit direction of sheets S discharged from the second exit port 32 to the first sheet processing device 6 through the second transport path 42 are set to be the same.

In addition, in the image forming apparatus 2 of the second exemplary embodiment, the sheets S, which are formed with an image in the image forming unit 10, are transported in the first transport path 41 and the second transport path 42 of the sheet transport path 40 in a state where the image forming surfaces are directed downward (face-down state).

Accordingly, in the image forming system 1 of the second exemplary embodiment, the sheets S are transported to the first sheet processing device 6 and the second sheet processing device 8 in a state where the image forming surfaces are directed downward. For this reason, in the second exemplary embodiment, the binding position or the binding direction for the sheets S may be controlled by the same software in the first sheet processing device 6 and the second sheet processing device 8.

### OTHER MODIFICATIONS

In the descriptions of the first exemplary embodiment and the second exemplary embodiment, descriptions have been made on a case where concave and convex portions are formed on the sheet bundle to cause the sheets S to be press-bonded to each other with a needle-free binding processing performed by the needle-free binding mechanism 70 of the first sheet processing device 6 without using a staple needle, but the needle-free binding processing is not limited thereto.

For example, in the first sheet processing device 6, a sheet bundle may be bound by, for example, forming a slit and a tongue-shaped piece punched out except one end on, for example, the sheets S (sheet bundle), and bending the tongue piece to be inserted into the slit. In addition, the needle-free binding processing performed in the first sheet processing device 6 may be, for example, a binding processing using an adhesive or the like.

In addition, in the above description, a needle-free binding processing that does not use a staple needle and is performed by the needle-free binding mechanism 70 has been described as an example of the first binding processing, and a needle binding processing that uses a staple needle and is performed by the needle binding mechanism 90 has been described as an example of the second binding processing. However, the first binding processing and the second binding processing are not limited thereto. When a bonding strength between the sheets S by the first binding processing is small compared to a bonding strength between the sheets by the second binding processing, the first binding processing and the second binding processing may be the same types of binding processings.

In the description of the first exemplary embodiment, the first sheet processing device 6 has been described as a component that is accommodated in the first housing 66 to be mounted on the housing 30, but the first sheet processing device 6 may be a component that is directly accommodated inside of the housing 30 without being accommodated in the first housing 66.

In the description of the second exemplary embodiment, the first sheet processing device 6 and the second sheet processing device 8 have been described as components that are aligned inside the installation range W, but the first sheet processing device 6 and the second sheet processing device 8 may be aligned outside the installation range W (on the left side surface of the housing 30). In this configuration, in the up-down direction, the second sheet processing device 8 may be provided at the upper side and the first sheet processing device 6 may be provided at the lower side.

In the description of the first exemplary embodiment, it has been described that the first transport path 41 is configured to be longer than the second transport path 42, but the first transport path 41 may be configured to have the same length as the second transport path 42, or the first transport path 41 may be configured to be shorter than the second transport path 42.

In addition, in the description of the first exemplary embodiment or the secondary exemplary embodiment, the first sheet processing device 6 and the second sheet processing device 8 have been described as the sheet processing devices that are different from each other in terms of a binding processing aspect; however the first sheet processing device 6 and the second sheet processing device 8 may be the same type of sheet processing devices.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image forming unit configured to form an image on a sheet and provided in an apparatus body;
a first sheet processing device provided in a first housing and configured to perform a first binding processing, without using a needle, on the sheet that is formed with the image by the image forming unit and stacked; and
a second sheet processing device provided in a second housing that is different from the first housing and configured to perform a second binding processing, using a needle, on the sheet that is formed with the image by the image forming unit and stacked,
wherein the first housing and the second housing are mounted on the apparatus body,
at least a portion of the first housing is positioned within a range exclusively occupied by a rectangular space defined by a maximum outer dimension of the apparatus body, and
the second housing is positioned outside the rectangular space.

2. The image forming system according to claim 1, wherein the first housing includes a first mechanical unit configured to perform the first binding processing and included in the range exclusively occupied by the rectangular space, and
the second housing includes a second mechanical unit configured to perform at least the second binding processing and positioned outside the range exclusively occupied by the rectangular space.

3. The image forming system according to claim 1,
wherein the second housing includes an opened space above the second housing when the second housing is mounted on the apparatus body.

4. The image forming system according to claim 1, further comprising:
a first transport path configured to transport the sheet from the image forming unit toward the first sheet processing device; and
a second transport path configured to transport the sheet from the image forming unit toward the second sheet processing device,
wherein the first transport path is shorter than the second transport path.

5. The image forming system according to claim 1, further comprising:
a selection unit configured to select the second binding processing the second sheet processing device or the first binding processing by the first sheet processing device,
wherein the selection unit is configured to select the second binding processing in a case where a number of sheets to be subjected to a binding processing is equal to or larger than a predetermined reference number.

6. An image forming system comprising:
an image forming unit configured to form an image on a sheet and provided in an apparatus body;
a first sheet processing device provided in a first housing and configured to perform a first binding processing, without using a needle, on the sheet that is formed with the image by the image forming unit and stacked; and
a second sheet processing device provided in a second housing that is different from the first housing and configured to perform a second binding processing, using a needle, on the sheet that is formed with the image by the image forming unit and stacked,
wherein the first housing and the second housing are mounted on the apparatus body, and
the first housing is mounted on a position lower than that of the second housing.

7. The image forming system according to claim 6,
wherein the second housing includes an opened space above the second housing when the second housing is mounted on the apparatus body.

8. The image forming system according to claim 6, further comprising:
a first transport path configured to transport the sheet from the image forming unit toward the first sheet processing device; and
a second transport path configured to transport the sheet from the image forming unit toward the second sheet processing device,
wherein the first transport path is shorter than the second transport path.

9. The image forming system according to claim 6, further comprising:
a selection unit configured to select the second binding processing the second sheet processing device or the first binding processing by the first sheet processing device,
wherein the selection unit is configured to select the second binding processing in a case where a number of sheets to be subjected to a binding processing is equal to or larger than a predetermined reference number.

10. An image forming system comprising:
an image forming unit configured to form an image on a sheet and provided in an apparatus body;
a first sheet processing device provided inside the apparatus body and configured to perform a first binding processing, without using a needle, on the sheet that is formed with the image by the image forming unit and stacked; and
a second sheet processing device provided in a housing that is different from the apparatus body and configured to perform a second binding processing, using a needle, on the sheet that is formed with the image by the image forming unit and stacked.

11. The image forming system according to claim 10,
wherein the second housing includes an opened space above the second housing when the second housing is mounted on the apparatus body.

12. The image forming system according to claim 10, further comprising:
a first transport path configured to transport the sheet from the image forming unit toward the first sheet processing device; and
a second transport path configured to transport the sheet from the image forming unit toward the second sheet processing device,
wherein the first transport path is shorter than the second transport path.

13. The image forming system according to claim 10, further comprising:
a selection unit configured to select the second binding processing by the second sheet processing device or the first binding processing by the first sheet processing device,
wherein the selection unit is configured to select the second binding processing in a case where a number of sheets to be subjected to a binding processing is equal to or larger than a predetermined reference number.
